(19) United States
(12) Patent Application Publication
(10) Pub. No.: US 2003/0126294 A1
(43) Pub. Date: Jul. 3, 2003

(54) Transmitting digital video signals over an IP network

(76) Inventors: Thomas M. Thorsteinson, Winnipeg (CA); Steven A. Nikkel, Winnipeg (CA); David Tadashi Shimizu, Winnipeg (CA); Jose Alejandro Rueda, Winnipeg (CA); George F. Cosens, Winnipeg (CA)

Correspondence Address: ADE & COMPANY, 1700-360 MAIN STREET, WINNIPEG, MB, R3C3Z3, CA

(21) Appl. No.: 10/299,000

(22) Filed: Nov. 19, 2002

Related U.S. Application Data
(60) Provisional application No. 60/331,489, filed on Nov. 19, 2001.

(51) Int. Cl. G06F 15/16

(52) U.S. Cl. 709/247

(57) ABSTRACT

The device disclosed is capable of accepting and transmitting multiplexed compressed digital video, (Digital TV DTV/HDTV), in a MPEG2 Transport Stream (TS) form, from various devices and sources. It is intended to be used by broadcasting companies to leverage high-speed networks, for point to point and point to multipoint transmissions. The disclosure includes methods for Supporting DHCP and DNS. The processing of the received signals provides a Constant Delay for synchronization. This is obtained by providing at the receiving node provides buffering for accommodating network jitter and lost packages and for controlling the output bit rate. The buffering includes a buffer for retaining a predetermined quantity of data the effective size of which before the data is released is changed depending upon bit rate and the output bit rate is controlled by varying the amount of data retained. Remote Management and Monitoring function is provided based on the SNMP protocol and a remote management and monitoring function via the WWW and HTTP protocol. A design is provided for Point to Multipoint multicast Transmissions.

This application claims priority under 35 U.S.C.119 from Provisional Application Ser. No. 60/331,489 filed Nov. 19^{th} 2001.

### FIELD OF THE INVENTION

This invention relates to a method for transmitting digital video signals over an IP network.

The digital video broadcasting industry requires high-speed, low-latency communication links for transmission of production components and for distribution. Today, the video production process includes digital editing and integration of components from sometimes geographically distributed locations. Satellite transmission is the main communication link. Both digital and analog components are utilized.

Other typical transmission uses:

Delivery of live video program streams to the head-end or production studio

Transmission of movie or video rushes

Remote Broadcast

Delivery of live video to cable head-ends

Video Backhaul

Broadcasting companies are currently in the process of assessing the use of high-speed data networks. This will enhance the production, storage, and distribution process. Several major telecommunications carriers are involved in this type of study. Digital Video Broadcasting (DVB) is a standard that has emerged for digital video transmission. The standard is managed by the European Telecommunications Standards Institute (ETSI). It is a market-led initiative to standardize digital broadcasting and includes over 220 organizations in more than 30 countries. DVB equipment is widely available. DVB is based on the MPEG-2 standard. DVB interfaces are available for satellite, cable, terrestrial broadcast and studio equipment. It offers a lot of flexibility in terms of the type of data that can be carried.

Other digital video interface technologies are also used, such as the North American standards (ATSC), SMPTE 310M and 259M, also know as SDI, for example. From a network point of view, DVB is a transport technology that defines its own physical, media access, and network protocols. It is not compatible with mainstream data networking technologies.

The Internet protocol (IP) is the dominant protocol for implementation of multimedia network applications. At least one major telecommunications carrier has announced that the data business is larger than the voice business and for this reason is focusing on further development of IP-based offerings. In addition, network equipment providers continue to increase bandwidth to support high-quality multimedia applications.

Current video transport technology allows digital video signals to be modulated over analog channels to be transmitted via satellite, cable distribution systems and antenna systems, over the air. There are also products that can transmit digital video over existing telephone networks at speeds approaching 50 Mbps. Most of these products were designed to transport analog video, or low bit rate digital video in a point to point fashion.

There is a need for interfaces that will allow HDTV and DTV data to be transmitted over the new high speed IP based networks as we transition to digital television. Broadcasting companies will be using storage area network (SAN) technologies to archive contents and technology for back-haul of video from the studios to distribution points that may include cable head ends or affiliates. Broadcast networks could also use new technology to send their program stream to member stations.

This new transmission technology offers a much shorter time delay between points because the satellite delay is eliminated. This technology could also be used for interview applications were a response delay is annoying.

This technology can also be used for broadcasting sporting events. In a case where an event such as baseball or football is to be broadcast from a metropolitan area were high speed network bandwidth is available, a network interface could easily be established for point to point transmission between a stadium and the broadcasters' studio. It could be established for the duration of the sporting event and then disassembled.

The interface also has the potential of being applied at the home environment as a video acquisition board. Direct to theatre distribution of movies would be feasible using this technology.

DVB has a provision to transport user data as well as MPEG-2 program material. This capability can make use of the high bandwidth network connection to send very high-resolution medical images between hospitals and to central databases for storage and to specialists for diagnostic analysis. With the advances in IP network infrastructure towards high bandwidth connections, there is now a market for a device that transports digital video over an IP network. This device competes well with current methods such as using satellites and private networks, which are high cost, require a lengthy install time, and have issues of lower bandwidth and larger latencies.

### BACKGROUND PRIOR ART

There has been little work in this field because digital video is a relatively new thing, especially with broadcasters. In addition, it has not been technically or economically feasible to transmit digital video over long distances. Most of the work has been aimed to provide digital video over very low bandwidth connections. Thus most of the focus has been on encoding methods to reduce the bandwidth, rather than the transport techniques used to deliver the content. There is however, research into transporting MPEG digital video over ATM based networks. Almost all software that transmits digital video over IP networks utilizes the Real-Time Protocol.

A product has previously been available which is the Optibase MGW 3100, an Israeli company, which is identified hereinafter and provides a device which transmits digital video signals over IP networks. However this is presently no longer available and has a number of disadvantages.

The following documents are also of some interest in this field:

U.S. Patents:

U.S. Pat. No. 6,434,562 Computer system and method for providing digital video and data over a communication channel

U.S. Pat. No. 6,208,666 System and method for maintaining timing synchronization in a digital video network

U.S. Pat. No. 5,883,924 Method and apparatus for PCR jitter measurement in an MPEG-2 transport stream using sliding window

U.S. Pat. No. 5,640,388 Method and apparatus for removing jitter and correcting timestamps in a packet stream

U.S. Pat. No. 6,434,606 System for real time communication buffer management

U.S. Pat. No. 6,377,588 Method and apparatus for reducing jitter of a program clock reference in a transport stream of MPEG over ATM, and MPEG decoder

U.S. Pat. No. 5,534,937 Minimum-delay jitter smoothing device and method for packet video communications

U.S. Pat. No. 6,233,256 Method and apparatus for analyzing and monitoring packet streams

U.S. Pat. No. 6,208,643 Apparatus and method for analyzing bit streams

U.S. Pat. No. 6,429,902 Method and apparatus for audio and video end-to-end synchronization

U.S. Pat. No. 6,266,384 Method and apparatus for time base recovery and processing

U.S. Pat. No. 5,966,387 Apparatus and method for correcting jitter in data packets

U.S. Pat. No. 5,790,543 Apparatus and method for correcting jitter in data packets

U.S. Pat. No. 5,596,581 Recording and reproducing an MPEG information signal using tagged timing information

Application 20020024970 Transmitting MPEG data packets received from a non-constant delay network

Application 20020154640 Method of clock mismatch and drift compensation for packet networks

Related Articles and Standards:

Optimal Multicast Smoothing of Streaming Video over an Internetwork, IEEE Journal, S. Sen, D. Towsley, Z. Zhang and J. Dey, 1999

DVB Interfaces to SDH Networks, ETS 300 814 Standard

Synchronization of MPEG-2 based digital TV services over IP networks, Master Thesis at Telia Research AB, B. Kaxe, 2000

MPEG-2 Transport over ATM Networks, Masters Thesis at University of California, Santa Cruz, Christos Tryfonas, September 1996

RTP: A Transport Protocol for Real-Time Applications, RFC1889, H. Schulzrinne, S. Casner, R. Frederick and V. Jacobson, January 1996

RTP Profile for Audio and Video Conferences with Minimal Control, RFC1890, H. Schulzrinne, January 1996

RTP Payload Format for MPEG1/MPEG2 Video, RFC2250, D. Hoffman, G. Fernando, V. Goyal and M. Civanlar, January 1998

Extension of RTP Payload Type for Multiple Program MPEG Transport Streams, draft-ietf-avt-rtp-mp2t-00, H. Liu, March 2000

Information Technology—Generic coding of moving pictures and associated audio information: Systems, ISO/IEC Standard 13818-1 (The MPEG2 Standard), 1996

MPEG Video Compression Standard, J. Mitchell, W. Pennebaker, C. Fogg and D. LeGall, 1997

Real-Time Transport Protocol Management Information Base, draft-ietf-avt-rtp-mib-13, M. Baugher, I. Suconick and B. Strahm, May 2000

Transport of MPEG-2 Constant Bit Rate Television Signals in B-ISDN (ATM), ITU-T Rec.J.82, July 1996

Transport of MPEG-2 signals in SDH Networks, ITU-T Rec.J.132, March 1998

Transport of MPEG-2 signals in PDH Networks, ITU-T Rec.G.703

Monitoring of Audio, Video and Data in a Multi-Channel Facility: SMPTE 35^{th} Advanced Motion Imaging Conference Capital Hilton, Washington D.C., David Strachan, Evertz Microsystems, Ltd. Feb. 8-11^{th}, 2001.

An SNMP Agent for a DTV Data Server, SMPTE 35^{th} Advanced Motion Imaging Conference Capital Hilton, Washington D.C., Dinkar Bhat, David Catapano, James Kenealy, Gomer Thomas, Feb. 8-11^{th}, 2001.

ETS 300 813 Digital Video Broadcasting (DVB); DVB interfaces to Plesiochronous Digital Hierarchy (PDH) networks

ETS 300 814 Digital Video Broadcasting (DVB); DVB interfaces to Synchronous Digital Hierarchy (SDH) networks

ETS 300 818 Broadband Integrated Services Digital Network (B-ISDN); Asynchronous Transfer Mode (ATM); Retainability performance for B-ISDN switched connections

Optibase MGW 3100 (http://www.optibase.com/html/products/Media₁₃Gateways/MGW₁₃ 3100.html)

Notation:

SDH: Synchronous Digital Hierarchy (a superset of SONET, used to carry most modern high-speed backbone links)

PDH: Plesiochronous Digital Hierarchy (Old-world style Telco network, with voice channels and TDM, the Tx/Ex style links)

MPEG: Motion Pictures Experts Group (http://www.cselt.it/mpeq/ and also www.mpeg.org)

SMPTE: Society of Motion Pictures Technical Engineers (www.smpte.org)

DVB: Digital Video Broadcasting (www.dvb.org, DVB Standards are under www.etsi.org and http://server.cenelec.be)

ATSC: Advanced Television Standards Committee (www.atsc.orq, the US equivalent to the European DVB Project)

ASI: Asynchronous Serial Interface

SDI: Serial Digital Interface

RFC: Request For Comment (De facto standard for internet protocols)

IP: Internet Protocol (RFC 791)

TCP: Transmission Control Protocol (RFC 793)

UDP: User Datagram Protocol (RFC 768)

RTP: Real-Time Protocol (RFC 1889, 1890, 2250)

SSRC: Synchronization Source (from RTP)

MTU: Maximum Transmission Unit (TCP/IP)

GbE: Gigabit Ethernet (IEEE 802)

MP2TS: MPEG 2 Transport Stream (ISO/IEC 13818-1)

TS: Transport Stream (referring to an MPEG 2 Transport Stream)

QoS: Quality of Service

Diffserv: Differentiated Services (RFC 2998)

DHCP: Dynamic Host Configuration Protocol (RFC 2131)

DNS: Domain Name Service (RFC 1034,1035)

SNMP: Simple Network Management Protocol (RFC 1157)

IGMP: Internet Group Multicast/Management Protocol (RFC 2236)

WWW: World Wide Web (http://www.w3c.org)

PHP: PHP Hypertext Preprocessor (server-side scripting language, http://www.php.net)

HTTP: Hyper Text Transfer Protocol (RFC 1855, world wide web protocol)

CGI: Common Gateway Interface (web scripting facility)

HTML: Hyper Text Markup Language (http://www.w3c.org)

MIB: Management Information Base

GUI: Graphical User Interface

### SUMMARY OF THE INVENTION

The object of the invention is to be a competitive technology to current Satellite broadcast methods for most point-to-point digital television back-haul applications. In the future when fiber is installed everywhere, then it will also be a competitive technology to satellite (lower cost) for point to multi-point applications. High-speed fiber IP networks are now being installed worldwide. These networks provide a high-speed backbone for voice, data and video applications. The invention enables transport of DVB or ATSC digital video over wide-area IP networks, see FIG. 1. This provides an alternative to satellite links for video backhauling, remote broadcasts, or distribution to cable head-ends. The invention is designed to decrease the latency of transmission as opposed to satellite links. It is designed to significantly reduced equipment cost and operation cost for broadcast transmission. In addition the invention affords a much greater geographic and location portability of the device, due to its ease of configuration and widespread availability of network access. The invention affords much versatility of location of the devices as there are no limitations due to satellite footprints, nor the requirement for retransmission from remote locations. The invention is also designed to be adaptable and versatile to be easily extensible to other functions.

According to a first aspect of the invention there is provided a method for transmitting digital video signals comprising:

providing a transmitter node and a receiver node each connected to an IP network;

providing at the transmitter node an input for receiving multiplexed compressed digital video in a MPEG2 Transport Stream form containing MPEG2 Transport Stream packets from a source;

providing at the receiver node an output for transmitting multiplexed compressed digital video in a MPEG2 Transport Stream form to a receiver;

at the transmitter node, extracting the data from the MPEG2 Transport Stream, encapsulating that data in IP network packets each containing the data from a plurality of MPEG2 Transport Stream packets and transmitting the IP network packets addressed to the receiver node over the IP network from the transmitter node to the receiver node;

at the receiver node, receiving the IP network packets, extracting the data therein, encapsulating the data into a MPEG2 Transport Stream and transmitting the MPEG2 Transport Stream to the receiver;

wherein the receiving node transmits the MPEG2 Transport Stream at a predetermined required output bit rate equal to the bit rate of the stream from the source;

and wherein the IP network packets are jumbo Ethernet frames.

Preferably the jumbo Ethernet frame size is at least 1501 bytes.

Preferably the transmitting node selects a jumbo Ethernet frame format from a plurality of different available formats depending upon the frame format which can be accepted by the IP network.

Preferably the transmitting node selects a format in response to an automatic detection of the available format on the network.

According to a second aspect of the invention there is provided a method for transmitting digital video signals comprising:

providing a transmitter node and a plurality of receiver nodes each connected to an IP network;

providing at the transmitter node an input for receiving multiplexed compressed digital video in a MPEG2 Transport Stream form containing MPEG2 Transport Stream packets from a source;

providing at each of the receiver nodes an output for transmitting multiplexed compressed digital video in a MPEG2 Transport Stream form to a respective receiver;

at the transmitter node, extracting the data from the MPEG2 Transport Stream, encapsulating that data in IP network packets each containing the data from a plurality of MPEG2 Transport Stream packets and transmitting the IP network packets over the IP network from the transmitter node to the receiver node;

at the receiver nodes, receiving the IP network packets, extracting the data therein, encapsulating the data into a MPEG2 Transport Stream and transmitting the MPEG2 Transport Stream to the respective receiver;

wherein the receiving node transmits the MPEG2 Transport Stream at a predetermined required output bit rate equal to the bit rate of the stream from the source;

and wherein the transmitter node is arranged to address the IP network packages such that each transmitted packet is directed by the network to each of the receiver nodes in a multicast arrangement.

Preferably the receiver node requests participation in the multicast arrangement.

According to a third aspect of the invention there is provided a method for transmitting digital video signals comprising:

providing a transmitter node and a receiver node each connected to an IP network;

providing at the transmitter node an input for receiving multiplexed compressed digital video in a MPEG2 Transport Stream form containing MPEG2 Transport Stream packets from a source;

providing at the receiver node an output for transmitting multiplexed compressed digital video in a MPEG2 Transport Stream form to a receiver;

at the transmitter node, extracting the data from the MPEG2 Transport Stream, encapsulating that data in IP network packets each containing the data from a plurality of MPEG2 Transport Stream packets and transmitting the IP network packets addressed to the receiver node over the IP network from the transmitter node to the receiver node;

at the receiver node, receiving the IP network packets, extracting the data therein, encapsulating the data into a MPEG2 Transport Stream and transmitting the MPEG2 Transport Stream to the receiver;

wherein the receiving node transmits the MPEG2 Transport Stream at a predetermined required output bit rate equal to the bit rate of the stream from the source;

wherein the receiver node and the transmitter node are arranged to support DHCP configuration of its network interfaces to improve the manageability and to support DNS name resolution to improve the configurability of the operation.

According to a fourth aspect of the invention there is provided a method for transmitting digital video signals comprising:

providing a transmitter node and a receiver node each connected to an IP network;

providing at the transmitter node an input for receiving multiplexed compressed digital video in an input MPEG2 Transport Stream form containing MPEG2 Transport Stream packets from a source;

providing at the receiver node an output for transmitting multiplexed compressed digital video in an output MPEG2 Transport Stream form to a receiver;

at the transmitter node, extracting the data from the MPEG2 Transport Stream, encapsulating that data in IP network packets each containing the data from a plurality of MPEG2 Transport Stream packets and transmitting the IP network packets addressed to the receiver node over the IP network from the transmitter node to the receiver node;

at the receiver node, receiving the IP network packets, extracting the data therein, encapsulating the data into a MPEG2 Transport Stream and transmitting the MPEG2 Transport Stream to the receiver;

wherein the receiving node transmits the MPEG2 Transport Stream at a predetermined required output bit rate equal to the bit rate of the stream from the source;

wherein the receiving node provides buffering for accommodating network jitter and lost packages and for controlling the output bit rate;

and wherein the buffering is controlled to provide a predetermined constant time delay between the input stream and the output stream.

Preferably the delay is of the order of 0.5 seconds.

Preferably the transmitter node is arranged for receiving different input streams at different bit rates and the buffering is arranged to maintain the same delay for different bit rates.

Preferably the buffering includes a buffer for retaining a predetermined quantity of data the effective size of which before the data is released is changed depending upon bit rate.

Preferably the output bit rate is controlled by varying the amount of data retained.

Preferably at the transmitter node there is applied to each transmitted packet an accurate time stamp and wherein the input rate is determined at the receiver node by detecting the time stamp of a plurality of sequential packets and the quantity of data therein.

Preferably the input rate is determined taking into account lost and erroneous packets.

Preferably the buffering includes a buffer for retaining a predetermined quantity of data the effective size of which before the data is released is changed depending upon bit rate and wherein the lost and erroneous packets are replaced by null packets prior to inputting the packets into the buffer.

Preferably the buffer size is maintained at substantially a minimum so as to minimize the delay.

Preferably each time a network packet is received, the software checks the RTP timestamp to see if its sampling interval has elapsed where the interval should be much longer than the difference between consecutive RTP timestamps, such that the actual sampling intervals are almost uniform; the variation in the RTP packet arrival times is ignored; if the sampling interval has passed, the software compares the actual circular buffer level to the desired half-full level and uses this difference as the error signal for a digital feedback control system; this error signal is applied to a proportional-integral (PI) compensator whose output is the bit rate; the gains of the proportional and integral blocks are set such that the control loop is stable and highly damped, to reject variations in the RTP packet arrival times; the bit rate is applied to the circular buffer, which acts as a second integrator and produces the actual buffer level used in the error signal calculation; each time the sampling interval elapses, the bit rate of the DVB ASI interface is updated; since the actual output bit rate is controlled by the hardware interface, it is very stable; and the control loop makes minor changes to the bit rate over long periods of time, resulting in an overall bit rate within tolerances of transport stream standards for jitter and drift.

According to a fifth aspect of the invention there is provided a method for transmitting digital video signals comprising:

providing a transmitter node and a receiver node each connected to an IP network;

providing at the transmitter node an input for receiving multiplexed compressed digital video in an input MPEG2 Transport Stream form containing MPEG2 Transport Stream packets from a source;

providing at the receiver node an output for transmitting multiplexed compressed digital video in an output MPEG2 Transport Stream form to a receiver;

at the transmitter node, extracting the data from the MPEG2 Transport Stream, encapsulating that data in IP network packets each containing the data from a plurality of MPEG2 Transport Stream packets and transmitting the IP network packets addressed to the receiver node over the IP network from the transmitter node to the receiver node;

at the receiver node, receiving the IP network packets, extracting the data therein, encapsulating the data into a MPEG2 Transport Stream and transmitting the MPEG2 Transport Stream to the receiver;

wherein the receiving node transmits the MPEG2 Transport Stream at a predetermined required output bit rate equal to the bit rate of the stream from the source;

wherein the receiving node provides buffering for accommodating network jitter and lost packages and for controlling the output bit rate;

wherein the buffering includes a buffer for retaining a predetermined quantity of data the effective size of which before the data is released is changed depending upon bit rate;

and wherein the output bit rate is controlled by varying the amount of data retained.

Preferably at the transmitter node there is applied to each transmitted packet an accurate time stamp and wherein the input rate is determined at the receiver node by detecting the time stamp of a plurality of sequential packets and the quantity of data therein.

Preferably the input rate is determined taking into account lost and erroneous packets.

Preferably the lost and erroneous packets are replaced by null packets prior to inputting the packets into the buffer.

Preferably the buffer size is maintained at substantially a minimum so as to minimize the delay.

According to a sixth aspect of the invention there is provided a method for transmitting digital video signals comprising:

providing a transmitter node and a receiver node each connected to an IP network;

providing at the transmitter node an input for receiving multiplexed compressed digital video in an input MPEG2 Transport Stream form containing MPEG2 Transport Stream packets from a source;

providing at the receiver node an output for transmitting multiplexed compressed digital video in an output MPEG2 Transport Stream form to a receiver;

at the transmitter node, extracting the data from the MPEG2 Transport Stream, encapsulating that data in IP network packets each containing the data from a plurality of MPEG2 Transport Stream packets and transmitting the IP network packets addressed to the receiver node over the IP network from the transmitter node to the receiver node;

at the receiver node, receiving the IP network packets, extracting the data therein, encapsulating the data into a MPEG2 Transport Stream and transmitting the MPEG2 Transport Stream to the receiver;

wherein the receiving node transmits the MPEG2 Transport Stream at a predetermined required output bit rate equal to the bit rate of the stream from the source;

wherein the receiver and transmitter nodes include a remote monitoring function based on the SNMP protocol and a remote management and monitoring function via the WWW and HTTP protocol.

Preferably both the SNMP and WWW interfaces obtain the monitoring information from several variables recorded by the software of the node and stored in a shared memory location of the node.

Preferably access control is implemented on the shared memory location to maintain accuracy of information.

Preferably the SNMP protocol utilizes a MIB specification to implement the function.

Preferably the WWW interface also links directly to the configuration and log files and system software for management functions.

Preferably the WWW interface is implemented in industry standard HTML and PHP software.

### BRIEF DESCRIPTION OF THE DRAWINGS

One embodiment will now be described in conjunction with the accompanying figure and Appendices in which:

Figures

FIG. 1 depicts an overview of the invention's overall usage.

FIG. 2 describes the modular hardware interface configuration.

FIG. 3 shows a typical network connection for the invention.

FIG. 4 illustrates the logical software configuration of the invention.

FIG. 5 illustrates the network packet encapsulation and packet overhead considerations.

FIG. 6 shows the buffer control algorithm.

### APPENDICES

Appendix 1 displays the SNMP MIB specification for the device.

Appendix 2 illustrates the shared memory structure used for remote management.

Appendix 3 shows example pseudo code for transmit and receive functions of the invention.

### DETAILED DESCRIPTION

The device is capable of accepting and transmitting multiplexed compressed digital video, (Digital TV DTV/HDTV), in a MPEG2 Transport Stream (TS) form, from various devices and sources. It includes DVB ASI and SMPTE 310M and state-of-the-art IP interfaces. It is intended to be used by broadcasting companies to leverage high-speed networks, for point to point and point to multipoint transmissions.

The invention includes methods for Supporting DHCP and DNS, Constant Delay, Frame Optimization, Remote Management and Monitoring, Utilizing Network QoS Protocols, Transmitting at High Bit Rates and Operating with Lower Costs and designs for Point to Multipoint Transmissions, Extensible Modular System and Lower Cost System.

Design for Point to Multipoint Transmissions

The device is capable of transmitting data in a point to multipoint fashion utilizing multicast protocols. A transmitter node sets the multicast TTL also known as the scope for the outgoing packets. In addition, a transmitter node allows selection from a plurality of network interfaces within the invention for the multicast arrangement. A receiver node requests participation in the multicast arrangement through the use of the IGMP protocol.

Method for Supporting DHCP and DNS

The invention is capable of utilizing DHCP client software for the configuration of its network interfaces and parameters. The invention is capable of communicating with name servers for translation of network names to addresses used for operation. The invention is capable of using network names as configuration parameters for operation. Supporting these protocols improves configurability and ease of use of the device. Other existing technology does not support these protocols.

Method for Constant Delay

From a simplified point of view, the invention bridges a synchronous connection, an MPEG 2 Transport Stream, over an unreliable asynchronous connection, an IP network. An important element of the invention is therefore the method for recreating the precise timing required by an MPEG 2 Transport Stream while managing errors introduced by unreliable IP networks. The invention utilizes a two stage approach.

The first stage originates in a transmitter node. A transmitter node uses an accurate hardware clock described elsewhere, to timestamp network packets which contain transport stream packets obtained from a source at an arbitrary bit rate. A receiver node estimates the transport stream bit rate from the timestamps contained in network packets it receives and the quantity of transport stream packets received. This estimation takes place over arbitrary period, for example, 0.2 seconds. It takes into account lost and erroneous network packets in its estimation. Lost packets are detected through the use of a sequence number in the network packet and are replaced with MPEG 2 Transport Stream null packets. Replacing lost transport stream packets with null packets does not recover missing data elements, but is used to maintain the precise timing of the transport stream. Numerous potential errors in the packet structure and headers are detected and discarded; any discarded packets are replaced with null packets. During the period when the estimation is taking place, measurements of network jitter can be taken using the network packet timestamps, since the MPEG 2 Transport Stream can be assumed to be constant bit rate.

MPEG 2 Transport Stream data arrives periodically from the source at a transmitter node. This data is transmitted to the network periodically as well. However, the affects of jitter in the network mean that the packets arrive in a non-periodic fashion at a receiver node. In order for a receiver node to output the transport stream packets periodically it must maintain a buffer of transport stream packets, such that there is always a packet available to output at the required time. For optimal resiliency, the buffer level has to be kept at fifty percent capacity. To increase resiliency you create a larger buffer, however as the size of the buffer increases so too does the latency of data through the device. End users of the device, namely broadcasters, desire a minimal latency. Thusly, the buffer size is minimized while maintaining a sufficient size for jitter and error resiliency. The bit rate and network jitter estimates can be used to optimize the buffer size. The calculation would take the following form, where M and N are constants:

Buffer Size=2*((M*Jitter Estimate)+N)*Bit Rate Estimate

Alternatively, the invention uses the bit rate estimate and a fixed delay specification for sizing the buffer. The calculation would take the following form, with a fixed delay of 0.5 seconds:

Buffer Size=2*(0.5 seconds*Bit Rate Estimate)

End users of the device desire a constant low delay to maintain synchronization of schedules and for ease of use. In order to achieve this result, the average buffer level in a receiver node must be held constant. The second stage implements a bit rate control function in order to maintain the average buffer level.

A receiver node can be modeled as shown in FIG. 6. The data flowing into the system is a ramp disturbance. To track a ramp with zero steady-state error, the open-loop transfer function

$$\frac{{G}_{C}}{s}$$

Needs Two Integrations. Suppose we use proportional-integral-derivative (PID) compensation;

$${G}_{c} = \frac{{K}_{D} {s}^{2} + {K}_{P} s + {K}_{I}}{s}$$

where K_{D}, Kₚ, and K_{I} are the derivative, proportional, and integral gains respectively.

The closed-loop transfer function is then

$$\frac{{G}_{C}}{s + {G}_{C}} = \frac{{K}_{D} {s}^{2} + {K}_{P} s + {K}_{I}}{{s}^{2} + {K}_{D} {s}^{2} + {K}_{P} s + {K}_{I}}$$

It is common knowledge that the optimum closed loop transfer function based on the integral of time multiplied by the absolute error (ITAE) for a ramp input in this case is

$$\frac{3.2 {ω}_{n} s + {ω}_{n}^{2}}{{s}^{2} + 3.2 {ω}_{n} s + {ω}_{n}^{2}}$$

where ωₙ controls the response of the system. Therefore, K_{D}=0, Kₚ=3.2ωₙ and K_{I}=ωₙ².

Using the bilinear transformation

$$s = \frac{2 ( 1 - {z}^{- 1} )}{T ( 1 + {z}^{+ 1} )}$$

where T is the sampling interval, we can find a digital filter equivalent to the analog compensator;

$${G}_{C} = \frac{outputrate}{error} = \frac{2 {K}_{P} ( 1 - {z}^{- 1} ) + {K}_{I} T ( 1 + {z}^{- 1} )}{2 ( 1 - {z}^{- 1} )}$$

This may be implemented as

$${outputrate}_{n} = {outputrate}_{n - 1} + \frac{2 {K}_{P} + {K}_{I} T}{2} {error}_{n} + \frac{{K}_{I} T - 2 {K}_{P}}{2} {error}_{n - 1}$$

The value of ωₙ must be chosen such that the compensator break frequency is less than the sampling rate and the system is stable.

Each time a network packet is received by a receiver node, it checks the RTP timestamp to see if its sampling interval has elapsed. This interval should be much longer than the difference between consecutive RTP timestamps, such that the actual sampling intervals are almost uniform. The variation in the RTP packet arrival times is ignored here. If the sampling interval has passed, the device compares the actual buffer level to the desired half-full level. It then uses this difference as the error signal for a digital feedback control system as described previously. This error signal is applied to the compensator, whose output is the bit rate. The control loop is highly damped to reject variations in the RTP packet arrival times. The bit rate is applied to the buffer, which acts as a second integrator and produces the actual buffer level used in the error signal calculation. Each time the sampling interval elapses, the bit rate of the video interface is updated. Since the actual output bit rate is controlled by the hardware interface, it is very stable. The control loop makes minor changes to the bit rate over long periods of time, resulting in an overall bit rate within tolerances of MPEG 2 Transport Stream standards for jitter and drift. In addition, the specific interface utilized within the preferred embodiment, which is described elsewhere, has configurations to minimize jitter which are fully utilized by the invention. Similar methods are used in this stage as the first stage for error management.

As a result of synchronizing the output bit rate to the input rate of the system the average buffer level is held constant. This achieves the desired result of constant low delay.

Method for Frame Optimization

A node of the invention must expend resources and processing time for each network packet transmitted or received. Since the invention operates at high bit rates the packet rate is also high. This becomes a significant bottleneck to the device's operation. In order to minimize the required resources one can simply reduce the number of packets. The device accomplishes this by encapsulating the maximum number of TS packets per network packet. Typically the maximum network packet size is limited by the hardware's maximum frame size. Fragmentation allows this limitation to be overcome, however it is not practical. The device also utilizes jumbo Ethernet frames to increase the packet capacity beyond the 1500 byte limitation of Ethernet.

A transmitter node is capable of automatically detecting the maximum packet size, also called the MTU, supported by the network connection. The invention implements a well known protocol called Path MTU Discovery. Path MTU discovery has the downside of periodically losing packets which is detrimental to video transmission. The invention additionally implements a modified version of Path MTU discovery wherein the Path MTU is only discovered once at the initiation of the session. This avoids the periodic packet loss problem. This can be implemented in two ways. The first maintains the Don't Fragment setting which allows for the possibility of a session timeout if network conditions change. On the other hand, removing the Don't Fragment setting allows the session to continue but introduces the possibility of incurring the additional overhead of packet fragmentation. Alternatively the device is capable of allowing a user to specify the frame size.

A receiver node implements functions to automatically detect the network packet size as well as the transport stream packet size it is receiving. A receiver node calculates the network packet size from length information in the packet header inserted by a transmitter node. The transport stream packet size is determined by checking if the data size present in the network packet is an integer multiple of a 188 or 204 byte TS packet. The data is further scanned for the unique TS sync byte present in integer multiples of the TS packet size.

Method for Remote Management and Monitoring

The device is designed with remote management and monitoring functions. Each device stores information in a shared memory location. To maintain accuracy of the information stored in shared memory, access is controlled using a semaphore. The shared memory location contains information used to monitor the operation of the device. Examples of the information include bit rate, buffer levels and system state. The complete memory structure is shown in FIG. 8.

The device implements the SNMP protocol by accessing information contained within the shared memory location in response to queries from SNMP clients. A network management station would use the MIB specification displayed in FIG. 7 in order to monitor and manage devices.

The device implements a GUI interface for remote management and monitoring. The interface is created with industry standard HTML, PHP, Javascript and CGI code. This interface is accessible to any network connected host using standard WWW browsers and the HTTP protocol. The GUI interface manipulates configuration and log files used by the device and calls system functions in order to manage the device.

Method for Utilizing Network QoS Protocols

The device implements Diffserv QoS tagging of IP packets. In addition, it is fully compatible with most other QoS standards as they are controlled via upstream routers or edge devices, see FIG. 3. Since Diffserv is already integrated, extending support for other protocols is straightforward.

Method for Transmitting at High Bit Rates

The device is designed to operate with high MP2TS bit rates. The preferred embodiment operates in excess of 150 Mbps (Megabits per second). Existing technology can only operate with lesser bit rates.

Design of Extensible Modular System

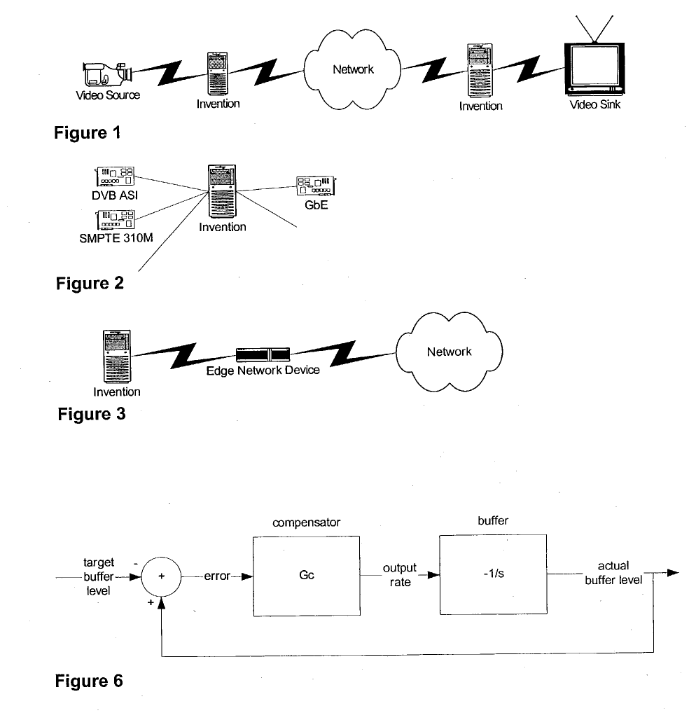

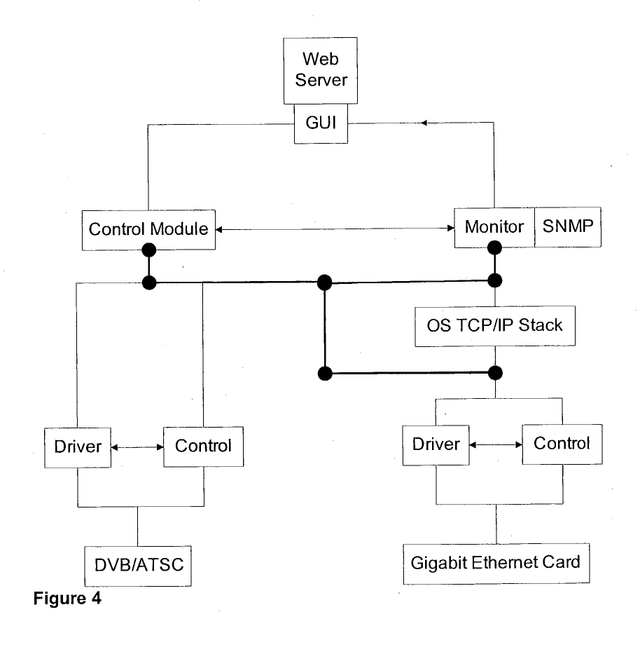

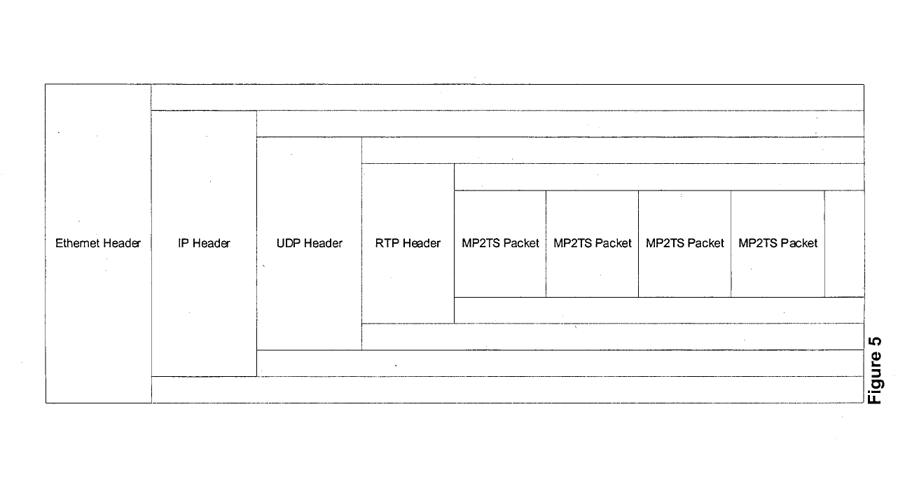

The invention is designed for the flexibility to incorporate a wide variety of video and network interfaces, see FIGS. 2 & 4. This was accomplished with abstraction of the devices and extended ranges in device configurations. The core software of the invention is divided into three modular components: A program file which performs the task of mapping the video and network, interfaces and protocols, and transporting and encapsulating the data. The two additional components provide SNMP and WWW GUI monitoring and management functions. The software was designed to be extensible.

Design of Lower Cost System

The invention has been designed with off the shelf components and simple devices in order to minimize the cost of the system. External development and manufacturing costs are also minimized for a lower cost design.

Method of Operating with Lower Costs

The device is design to utilize IP networks for transmission of broadcast video material. These networks provide a lower operating cost as compared to existing technology, such as satellite systems.

General Description

The device is a hardware/software product which transports a constant bit rate MPEG-2 transport stream (ISO/IEC 13818-1) over an IP network. It is composed of a fairly standard personal computer (PC) with a few special components, running Linux and some custom software. In addition to standard components, the PC is outfitted with digital video and network interfaces, most commonly a DVB ASI (EN 50083-9) and gigabit Ethernet interface respectively.

The device is available with a combination DVB input and output or a combination SMPTE 310M input and output. The device is suitable for use with private dark fiber networks, which can provide better access control and security.

2RU rack configuration (3.5″×18.9″×24.1″ with bezel)

275-watt PFC power supply

Conforms to FCC Class A, CE and UL

DVB ASI Interface

SMPTE 310M Interface

1000Base-SX Interface (SC multimode fiber)

10/100/1000Base-T Interface (RJ-45 copper)

UDP Unicast or Multicast

RTP as per RFC 1889, 1890, 2250

Ethernet or Jumbo packet sizes

10/100 Base-T control network interface

SNMP Monitor

Web based Manager

The device is configured to enable an inexperienced operator to set-up a session and start the transmission of the video. It provides a simple to use interface that uses as little technical jargon as possible to allow video technicians or anyone who is not used to wide area networking technology, to start the system working.

The setup is very easy and secure, allowing the possibility to use this technology for temporary remote broadcasts, such as soccer, football, or track and field events.

The units are designed for remote monitoring and control. A web-based GUI is provided for this and is selected by browsing to the machine's URL (for example, http://192.168.3.15). The GUI is intended for Microsoft Internet Explorer 5.0 or higher or Netscape Navigator 4.0 or higher. The home page of the GUI presents a menu of available channels and a download of the SNMP MIB. Each unit normally provides one transmit channel and one receive channel. Selecting one of the channels will display the status of the connection on that channel. From the status page, you can return to the initial selection screen by clicking on the graphic at the top center of the page.

The status page displays important operating parameters as well as the current status of the connection. When the connection is disabled, the status page will display the message “Process not running”. When the connection is enabled, the start time of the connection, as well as some status indicators are displayed. The status page updates automatically every second to provide current status information. Finally, the status page provides two control buttons to start and stop the connection. Also accessible from the status page are the two other major parts of the GUI, the configuration and log pages. These can be selected by clicking on the appropriate graphics at the top of the screen. You can return to the status page at any time by clicking on the status graphic at the top of the page.

The configuration page allows you to setup the stream transmission, the ASI input or output port is displayed at the top of the box. For a transmit channel the configurable parameters are listed below:

Destination parameter (required)—Destination is the IP address or network name of the unit at the other end of the bridge. This is the destination of the stream, where the MPEG-2 transport stream will be recovered.

Port parameter (optional)—The network port used by the destination unit to receive the data transmission (port 5004 by default).

Local address parameter (optional)—The IP address or network name of one of this unit's network interfaces. The default wildcard address is usually adequate, but if necessary this allows you to bypass normal system routing policies and use a specific interface for data transmission.

Multicast TTL parameter (required for multicast)—The multicast TTL (time-to-live) parameter. This parameter is ignored unless you are transmitting to a multicast IP address. The TTL parameter is used to limit the scope of the multicast transmission. There is no strict definition of multicast TTL; often it means the maximum number of hops or routers in the path. The minimum value for the TTL is 1, which will transmit to the local network only; the maximum is 255, which will probably attempt to circle the global network.

Type of Service parameter (optional)—The value of the Type-of-Service field in the IP packets. This is used to enable Quality of Service (QoS) protocols that may be available in your network. Please consult your network provider or administrator for details on this, as changing it to an unsupported value may decrease performance. The ToS value ranges from 0 to 254 and must be even.

Frame size parameter (optional)—The maximum Ethernet frame size available on the network. The units support jumbo Ethernet frames of up to 16114 bytes on the gigabit Ethernet interface, but many network devices do not support these large frames. The larger the frame size the better. The default value is 1500 bytes.

Transport stream packet size parameter—The MPEG-2 transport stream packet size. If you know the packet size, choose either 188- or 204-byte packets. Otherwise, choose Auto-detect.

For a receive channel, the ASI output port is given at the top of the configuration page. The configuration parameters are also somewhat different and are described following:

Local address parameter (optional)—The IP address or network name of one of this unit's network interfaces. You can use this to limit data connections to a specific interface if required. The default wildcard address will accept connections from all interfaces.

Port parameter (optional)—The network port used to receive the data transmission. This must match the destination port specified on the transmitting unit. The default is port 5004.

Multicast group parameter (required for multicast)—The multicast IP address or group to be used to receive data. If you are multicasting, use the destination address specified on the transmitter unit. Otherwise, leave this field blank.

Source parameter (optional)—The IP address or network name of the transmitting unit. Data from other addresses will be rejected.

ASI burst mode parameter—The burst mode setting of the ASI output port. When burst mode is enabled, no stuffing is inserted within the MPEG-2 transport stream packets. When burst mode is disabled, the maximum amount of stuffing for the stream bit rate is inserted.

The log page of the GUI provides a record of events that have occurred on this channel. The GUI will jump to the most recently logged events, which are at the bottom of the page. If many events have been logged, the page may be very long. You can use the Top link return to the top of the page. There may also be a Later or Earlier link at the bottom of the page, which provides access to logs from successive or previous days.

The device also features SNMPv1-based remote monitoring. Information similar to that provided by the web-based GUI is available to SNMP clients, but no parameters may be changed. The information is in the “public” community under the iso.org.dod.internet.private.enterprises.linearSystems.ipCasterTable.ipCasterEntry tree (1.3.6.1.4.1.10582.1.1.1). There is a separate table for each channel, represented by an index number. Transmit channels are numbered from 100 to 199, and receive channels are numbered from 200 to 299. The MIB is available from the system's GUI on the main page.

While running the software periodically updates several variables which are used to drive a SNMP monitoring facility as well as provide monitoring data to the GUI.

Parameters available in the shared memory include data to describe the system, software, operating status, packet sizes, internet addresses, errors and video stream parameters. These allow fairly detailed monitoring of the video stream and system.

Reference is made to the Appendices 1 to 3 as follows for further detail describing the detailed operation of the device.

[image]

[image]

[image]

[image]

[image]

[image]

[image]

[image]

[image]

[image]

[image]

[image]

[image]

[image]

[image]

[image]

1. A method for transmitting digital video signals comprising:
providing a transmitter node and a receiver node each connected to an IP network;
providing at the transmitter node an input for receiving multiplexed compressed digital video in a MPEG2 Transport Stream form containing MPEG2 Transport Stream packets from a source;
providing at the receiver node an output for transmitting multiplexed compressed digital video in a MPEG2 Transport Stream form to a receiver;
at the transmitter node, extracting the data from the MPEG2 Transport Stream, encapsulating that data in IP network packets each containing the data from a plurality of MPEG2 Transport Stream packets and transmitting the IP network packets addressed to the receiver node over the IP network from the transmitter node to the receiver node;
at the receiver node, receiving the IP network packets, extracting the data therein, encapsulating the data into a MPEG2 Transport Stream and transmitting the MPEG2 Transport Stream to the receiver;
wherein the receiving node transmits the MPEG2 Transport Stream at a predetermined required output bit rate equal to the bit rate of the stream from the source;
and wherein the IP network packets are jumbo ethernet frames.

2. The method according to claim 1 wherein the jumbo ethernet frame size is at least 1501 bytes.

3. The method according to claim 1 wherein the transmitting node selects a jumbo ethernet frame format from a plurality of different available formats depending upon the frame format which can be accepted by the IP network.

4. The method according to claim 1 wherein the transmitting node selects a format in response to an automatic detection of the available format on the network.

5. A method for transmitting digital video signals comprising:
providing a transmitter node and a plurality of receiver nodes each connected to an IP network;
providing at the transmitter node an input for receiving multiplexed compressed digital video in a MPEG2 Transport Stream form containing MPEG2 Transport Stream packets from a source;
providing at each of the receiver nodes an output for transmitting multiplexed compressed digital video in a MPEG2 Transport Stream form to a respective receiver;
at the transmitter node, extracting the data from the MPEG2 Transport Stream, encapsulating that data in IP network packets each containing the data from a plurality of MPEG2 Transport Stream packets and transmitting the IP network packets over the IP network from the transmitter node to the receiver node;
at the receiver nodes, receiving the IP network packets, extracting the data therein, encapsulating the data into a MPEG2 Transport Stream, and transmitting the MPEG2 Transport Stream to the respective receiver;
wherein the receiving node transmits the MPEG2 Transport Stream at a predetermined required output bit rate equal to the bit rate of the stream from the source;
and wherein the transmitter node is arranged to address the IP network packages such that each transmitted packet is directed by the network to each of the receiver nodes in a multicast arrangement.

6. The method according to claim 5 wherein the receiver node requests participation in the multicast arrangement.

7. A method for transmitting digital video signals comprising:
providing a transmitter node and a receiver node each connected to an IP network;
providing at the transmitter node an input for receiving multiplexed compressed digital video in a MPEG2 Transport Stream form containing MPEG2 Transport Stream packets from a source;
providing at the receiver node an output for transmitting multiplexed compressed digital video in a MPEG2 Transport Stream form to a receiver;
at the transmitter node, extracting the data from the MPEG2 Transport Stream, encapsulating that data in IP network packets each containing the data from a plurality of MPEG2 Transport Stream packets and transmitting the IP network packets addressed to the receiver node over the IP network from the transmitter node to the receiver node;
at the receiver node, receiving the IP network packets, extracting the data therein, encapsulating the data into a MPEG2 Transport Stream and transmitting the MPEG2 Transport Stream to the receiver;
wherein the receiving node transmits the MPEG2 Transport Stream at a predetermined required output bit rate equal to the bit rate of the stream from the source;
wherein the receiver node and the transmitter node are arranged to support DHCP configuration of its network interfaces to improve the manageability and to support DNS name resolution to improve the configurability of the operation.

8. A method for transmitting digital video signals comprising:
providing a transmitter node and a receiver node each connected to an IP network;
providing at the transmitter node an input for receiving multiplexed compressed digital video in an input MPEG2 Transport Stream form containing MPEG2 Transport Stream packets from a source;
providing at the receiver node an output for transmitting multiplexed compressed digital video in an output MPEG2 Transport Stream form to a receiver;
at the transmitter node, extracting the data from the MPEG2 Transport Stream, encapsulating that data in IP network packets each containing the data from a plurality of MPEG2 Transport Stream packets and transmitting the IP network packets addressed to the receiver node over the IP network from the transmitter node to the receiver node;
at the receiver node, receiving the IP network packets, extracting the data therein, encapsulating the data into a MPEG2 Transport Stream and transmitting the MPEG2 Transport Stream to the receiver;
wherein the receiving node transmits the MPEG2 Transport Stream at a predetermined required output bit rate equal to the bit rate of the stream from the source;
wherein the receiving node provides buffering for accommodating network jitter and lost packages and for controlling the output bit rate;
and wherein the buffering is controlled to provide a predetermined constant time delay between the input stream and the output stream.

9. The method according to claim 8 wherein the delay is of the order of 0.5 secs.

10. The method according to claim 8 wherein the transmitter node is arranged for receiving different input streams at different bit rates and the buffering is arranged to maintain the same delay for different bit rates.

11. The method according to claim 8 wherein the buffering includes a buffer for retaining a predetermined quantity of data the effective size of which before the data is released is changed depending upon bit rate.

12. The method according to claim 11 wherein the output bit rate is controlled by varying the amount of data retained.

13. The method according to claim 8 wherein at the transmitter node there is applied to each transmitted packet an accurate time stamp and wherein the input rate is determined at the receiver node by detecting the time stamp of a plurality of sequential packets and the quantity of data therein.

14. The method according to claim 13 wherein the input rate is determined taking into account lost and erroneous packets.

15. The method according to claim 14 wherein the buffering includes a buffer for retaining a predetermined quantity of data the effective size of which before the data is released is changed depending upon bit rate and wherein the lost and erroneous packets are replaced by null packets prior to inputting the packets into the buffer.

16. The method according to claim 11 wherein the buffer size is maintained at substantially a minimum so as to minimize the delay.

17. The method according to claim 11 wherein:
each time a network packet is received, the software checks the RTP timestamp to see if its sampling interval has elapsed where the interval should be much longer than the difference between consecutive RTP timestamps, such that the actual sampling intervals are almost uniform;
the variation in the RTP packet arrival times is ignored;
if the sampling interval has passed, the software compares the actual circular buffer level to the desired half-full level and uses this difference as the error signal for a digital feedback control system;
this error signal is applied to a proportional-integral (PI) compensator whose output is the bit rate;
the gains of the proportional and integral blocks are set such that the control loop is stable and highly damped, to reject variations in the RTP packet arrival times;
the bit rate is applied to the circular buffer, which acts as a second integrator and produces the actual buffer level used in the error signal calculation;
each time the sampling interval elapses, the bit rate of the DVB ASI interface is updated;
since the actual output bit rate is controlled by the hardware interface, it is very stable; and
the control loop makes minor changes to the bit rate over long periods of time, resulting in an overall bit rate within tolerances of transport stream standards for jitter and drift.

18. A method for transmitting digital video signals comprising:
providing a transmitter node and a receiver node each connected to an IP network;
providing at the transmitter node an input for receiving multiplexed compressed digital video in an input MPEG2 Transport Stream form containing MPEG2 Transport Stream packets from a source;
providing at the receiver node an output for transmitting multiplexed compressed digital video in an output MPEG2 Transport Stream form to a receiver;
at the transmitter node, extracting the data from the MPEG2 Transport Stream, encapsulating that data in IP network packets each containing the data from a plurality of MPEG2 Transport Stream packets and transmitting the IP network packets addressed to the receiver node over the IP network from the transmitter node to the receiver node;
at the receiver node, receiving the IP network packets, extracting the data therein, encapsulating the data into a MPEG2 Transport Stream and transmitting the MPEG2 Transport Stream to the receiver;
wherein the receiving node transmits the MPEG2 Transport Stream at a predetermined required output bit rate equal to the bit rate of the stream from the source;
wherein the receiving node provides buffering for accommodating network jitter and lost packages and for controlling the output bit rate;
wherein the buffering includes a buffer for retaining a predetermined quantity of data the effective size of which before the data is released is changed depending upon bit rate;
and wherein the output bit rate is controlled by varying the amount of data retained.

19. The method according to claim 18 wherein at the transmitter node there is applied to each transmitted packet an accurate time stamp and wherein the input rate is determined at the receiver node by detecting the time stamp of a plurality of sequential packets and the quantity of data therein.

20. The method according to claim 19 wherein the input rate is determined taking into account lost and erroneous packets.

21. The method according to claim 20 wherein the lost and erroneous packets are replaced by null packets prior to inputting the packets into the buffer.

22. The method according to claim 18 wherein the buffer size is maintained at substantially a minimum so as to minimize the delay.

23. The method according to claim 18 wherein:
each time a network packet is received, the software checks the RTP timestamp to see if its sampling interval has elapsed where the interval should be much longer than the difference between consecutive RTP timestamps, such that the actual sampling intervals are almost uniform;
the variation in the RTP packet arrival times is ignored;
if the sampling interval has passed, the software compares the actual circular buffer level to the desired half-full level and uses this difference as the error signal for a digital feedback control system;
this error signal is applied to a proportional-integral (PI) compensator whose output is the bit rate;
the gains of the proportional and integral blocks are set such that the control loop is stable and highly damped, to reject variations in the RTP packet arrival times;
the bit rate is applied to the circular buffer, which acts as a second integrator and produces the actual buffer level used in the error signal calculation;
each time the sampling interval elapses, the bit rate of the DVB ASI interface is updated;
since the actual output bit rate is controlled by the hardware interface, it is very stable; and
the control loop makes minor changes to the bit rate over long periods of time, resulting in an overall bit rate within tolerances of transport stream standards for jitter and drift.

24. A method for transmitting digital video signals comprising:
providing a transmitter node and a receiver node each connected to an IP network;
providing at the transmitter node an input for receiving multiplexed compressed digital video in an input MPEG2 Transport Stream form containing MPEG2 Transport Stream packets from a source;
providing at the receiver node an output for transmitting multiplexed compressed digital video in an output MPEG2 Transport Stream form to a receiver;
at the transmitter node, extracting the data from the MPEG2 Transport Stream, encapsulating that data in IP network packets each containing the data from a plurality of MPEG2 Transport Stream packets and transmitting the IP network packets addressed to the receiver node over the IP network from the transmitter node to the receiver node;
at the receiver node, receiving the IP network packets, extracting the data therein, encapsulating the data into a MPEG2 Transport Stream and transmitting the MPEG2 Transport Stream to the receiver;
wherein the receiving node transmits the MPEG2 Transport Stream at a predetermined required output bit rate equal to the bit rate of the stream from the source;
wherein the receiver and transmitter nodes include a remote monitoring function based on the SNMP protocol and a remote management and monitoring function via the WWW and HTTP protocol.

25. The method according to claim 24 wherein both the SNMP and WWW interfaces obtain the monitoring information from several variables recorded by the software of the node and stored in a shared memory location of the node.

26. The method according to claim 24 wherein access control is implemented on the shared memory location to maintain accuracy of information.

27. The method according to claim 24 wherein the SNMP protocol utilizes a MIB specification to implement the function.

28. The method according to claim 24 wherein the WWW interface also links directly to the configuration and log files and system software for management functions.

29. The method according to claim 24 wherein the WWW interface is implemented in industry standard HTML and PHP software.
